(19) United States
(12) Patent Application Publication
(10) Pub. No.: US 2026/0056421 A1
(43) Pub. Date: Feb. 26, 2026

(54) WEARABLE DEVICE FOR PROVIDING FLOATING IMAGES

(71) Applicants: CHING-TE SHIH, Kaohsiung City (TW); HAO-CHUN HSU, Taipei City (TW)

(72) Inventors: CHING-TE SHIH, Kaohsiung City (TW); HAO-CHUN HSU, Taipei City (TW)

(21) Appl. No.: 19/298,207

(22) Filed: Aug. 13, 2025

Related U.S. Application Data
(60) Provisional application No. 63/685,731, filed on Aug. 22, 2024.

(51) Int. Cl. G02B 30/56

(52) U.S. Cl. CPC G02B 30/56

(57) ABSTRACT

A wearable device for providing floating images includes a wearable module, an image display module and an optical imaging module. The image display module is configured to be disposed inside the wearable module and carried by the wearable module. The optical imaging module is configured to be disposed inside the wearable module and carried by the wearable module. The image display module is configured to provide a plurality of first image light beams projected toward a first predetermined direction to the optical imaging module inside the wearable module. The optical imaging module is configured to convert the first image light beams provided by the image display module into a plurality of second image light beams that are projected toward a second predetermined direction to leave the wearable module, thereby enabling the wearable device to be configured to provide a floating image composed of the second image light beams.

### CROSS-REFERENCE TO RELATED PATENT APPLICATION

This application claims the benefit of priority to the U.S. Provisional Patent Application Ser. No. 63/685,731, filed on Aug. 22, 2024, which application is incorporated herein by reference in its entirety.

### FIELD OF THE DISCLOSURE

The present disclosure relates to a wearable device, and more particularly to a wearable device for providing floating images.

### BACKGROUND OF THE DISCLOSURE

In the related art, the wearable device with display function can only provide a flat image screen for a user to watch, and the flat image screen provided by the wearable device cannot be adjusted in three dimensions. Therefore, the wearable device provided by the related art still has room for improvement.

### SUMMARY OF THE DISCLOSURE

In response to the above-referenced technical inadequacy, the present disclosure provides a wearable device for providing floating images.

In order to solve the above-mentioned problems, one of the technical aspects adopted by the present disclosure is to provide a wearable device for providing floating images, which includes a wearable module configured to be wearably disposed on a user, an image display module configured to be disposed inside the wearable module and carried by the wearable module, and an optical imaging module configured to be disposed inside the wearable module and carried by the wearable module. The image display module is configured to provide a plurality of first image beams projected toward a first predetermined direction onto the optical imaging module inside the wearable module. The optical imaging module is configured to respectively convert the first image beams provided by the image display module into a plurality of second image beams that are projected toward a second predetermined direction to leave the wearable module, thereby enabling the wearable device to be configured to provide a floating image composed of the second image beams. The first predetermined direction and the second predetermined direction are different or the same. The second image beams cooperate with each other to form the floating image on a virtual plane above the wearable module, thereby enabling the wearable device to be configured to provide the floating image for the user to watch.

These and other aspects of the present disclosure will become apparent from the following description of the embodiment taken referring to the following drawings and their captions, although variations and modifications therein may be effected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a schematic perspective view of a wearable device for providing floating images according to a first embodiment of the present disclosure;

FIG. 2 is a functional block diagram of the wearable device for providing floating images according to the first embodiment of the present disclosure;

FIG. 3 is a partial schematic cross-sectional view of the wearable device for providing floating images according to the first embodiment of the present disclosure;

FIG. 4 is a schematic side view of an optical imaging module of the wearable device for providing floating images according to the first embodiment of the present disclosure;

FIG. 5 is a schematic side view of a stereoscopic imaging module of the wearable device for providing floating images according to the first embodiment of the present disclosure;

FIG. 6 is a schematic side view of an electrochromic module of the wearable device for providing floating images according to the first embodiment of the present disclosure;

FIG. 7 is a schematic perspective view of the wearable device for providing floating images according to a second embodiment of the present disclosure;

FIG. 8 is a partial schematic cross-sectional view of the wearable device for providing floating images according to a third embodiment of the present disclosure;

FIG. 9 is a partial schematic cross-sectional view of the wearable device for providing floating images according to a fourth embodiment of the present disclosure; and

FIG. 10 is a schematic side view of an image display module applied to the wearable device according to a fifth embodiment of the present disclosure.

### DETAILED DESCRIPTION OF THE EXEMPLARY EMBODIMENTS

### First Embodiment

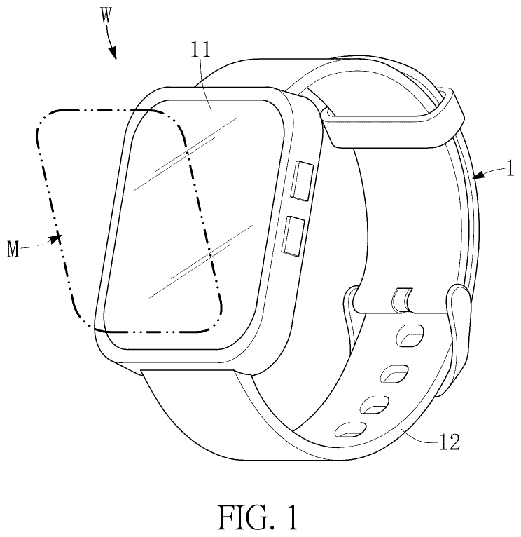

Referring to FIG. 1 to FIG. 6, the first embodiment of the present disclosure provides a wearable device W for providing a floating image M, which may at least include a wearable module 1, an image display module 2 and an optical imaging module 3, and the image display module 2 and the optical imaging module 3 may cooperate with each other to form a floating projection system.

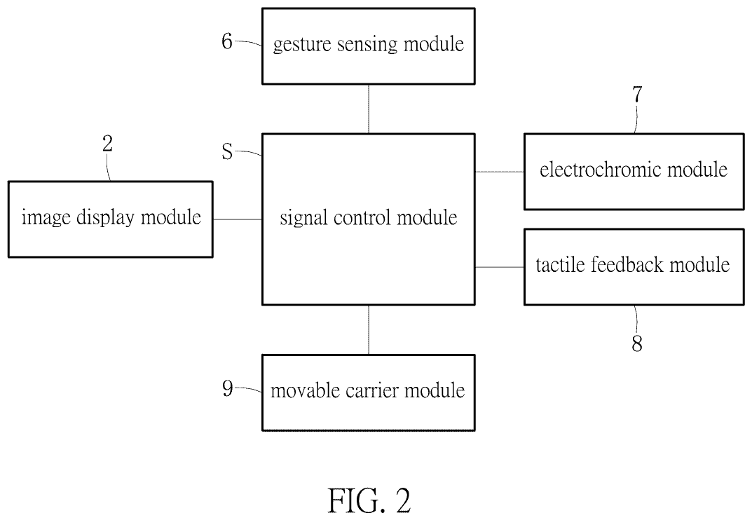

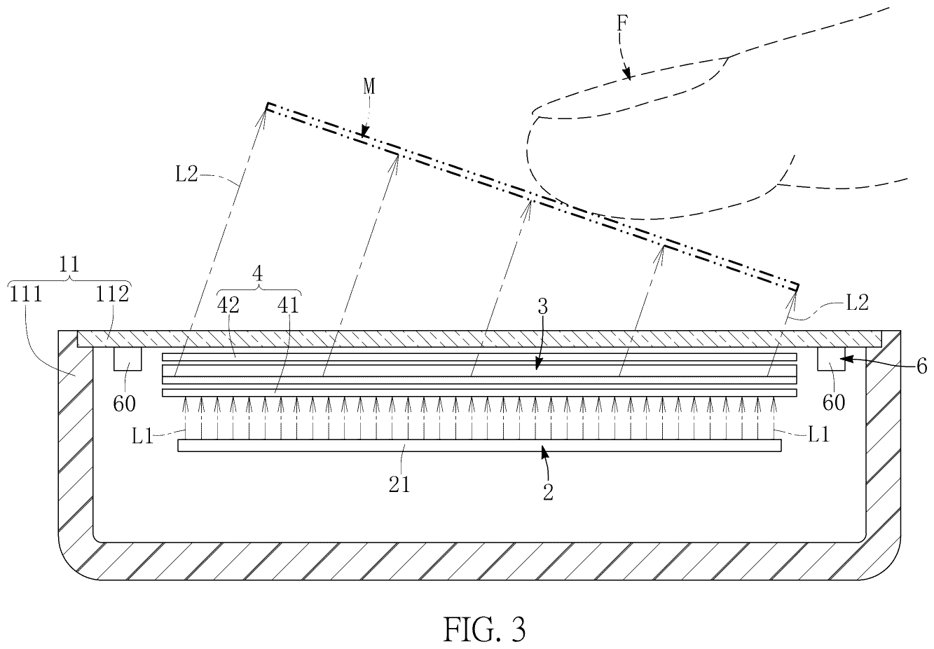

Furthermore, referring to FIG. 1, FIG. 2 and FIG. 3, the wearable module 1 may be configured to be wearably disposed on a user. For example, the wearable module 1 may include a device casing structure 11 and a wearable structure 12 (such as a wearable accessory) connected to (such as detachably or fixedly connected to) the device casing structure 11, the device casing structure 11 of the wearable module 1 may be configured as a watch casing (or a bracelet casing), and the wearable structure 12 of the wearable module 1 may be configured as a wristband watchband (or a wristband bracelet). Moreover, the device casing structure 11 of the wearable module 1 can be configured to carry the wearable structure 12, and the wearable structure 12 of the wearable module 1 can be configured to be wearably disposed on the user. In addition, the device casing structure 11 of the wearable module 1 may include an opaque casing 111 and a light-transmitting panel 112 (or a transparent substrate that can provide a transparent window) disposed on the opaque casing 111.

Furthermore, FIG. 1, FIG. 2 and FIG. 3, the image display module 2 can be configured to be disposed inside the wearable module 1 and carried by the wearable module 1, and the image display module 2 can be electrically connected to a signal control module S (or a signal processing module). In one of the feasible embodiments, the image display module 2 can be configured to provide a plurality of first image beams L1 that can be projected toward a first predetermined direction to the optical imaging module 3 inside the wearable module 1 (that is to say, the first image beams L1 can be projected toward the same or different first predetermined directions to the optical imaging module 3). For example, when the image display module 2 can be configured as a direct projection image display module (such as an image display module for directly projecting images that does not require an additional optical focusing lens group), the image display module 2 may include an image display 21 (such as a TFT display, a micro OLED display, a micro LED display, or a mini LED display), and the image display 21 can be configured to provide a plurality of first image light beams L1 that can be projected toward a first predetermined direction to the optical imaging module 3 inside the wearable module 1.

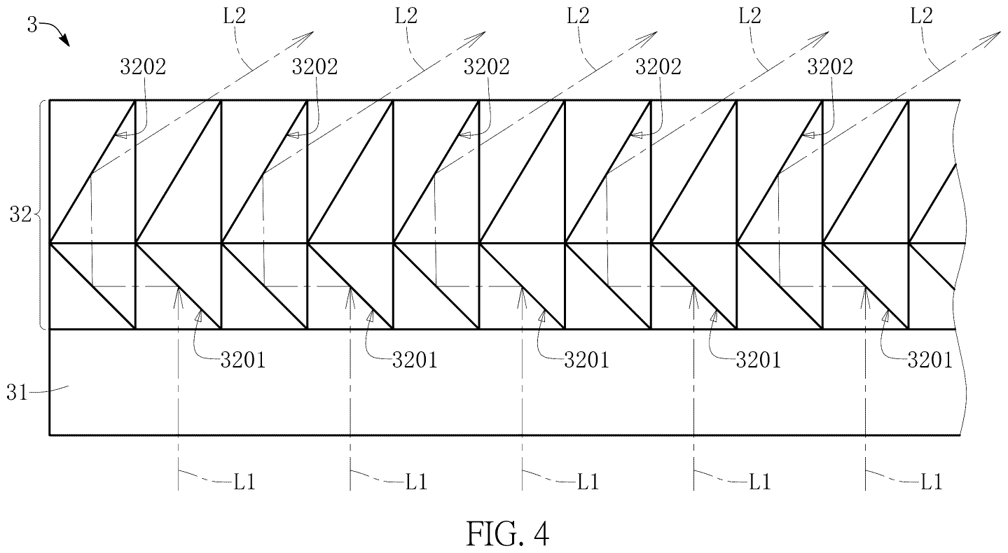

Furthermore, referring to FIG. 1, FIG. 3, and FIG. 4, the optical imaging module 3 can be configured to be disposed inside the wearable module 1 and carried by the wearable module 1. In one of the feasible embodiments, the optical imaging module 3 can be configured to optically convert (or optically reflect) the first image beams L1 that are provided by the image display module 2 into the second image beams L2 that are projected toward a second predetermined direction to leave the wearable module 1 (that is to say, the second image beams L2 can leave the wearable module 1 in the same or different second predetermined directions), so that the wearable device W can be configured to provide a floating image M composed of the second image beams L2. It is worth noting that the first predetermined direction and the second predetermined direction are two different directions (or the second predetermined direction can be inclined to the first predetermined direction) or two identical directions. For example, the optical imaging module 3 can be configured as a dihedral corner reflector array (DCRA) element. Furthermore, the optical imaging module 3 may include a light-transmitting carrier substrate 31 and an optical imaging assembly 32 (or two optical imaging assemblies stacked on each other) disposed on the light-transmitting carrier substrate 31, and the optical imaging assembly 32 may include a plurality of micro-prism arrays or a plurality of micro-reflector arrays that cooperate with each other. In addition, the optical imaging assembly 32 can be configured to provide a plurality of first reflection surfaces 3201 arranged in parallel to each other and a plurality of second reflection surfaces 3202 arranged in parallel to each other, and each first image beam L1 generated by the image display module 2 can be sequentially reflected by two adjacent first reflection surfaces 3201 and a corresponding second reflection surface 3202 to leave the optical imaging assembly 32 (that is to say, each first image beam L1 generated by the image display module 2 can be sequentially reflected by two adjacent first reflection surfaces 3201, and then reflected by a corresponding second reflection surface 3202, so as to project the second image beams L2 onto a virtual plane located above the wearable module 1).

For example, referring to FIG. 1, FIG. 2 and FIG. 3, the wearable device W can further include an imaging auxiliary module 4 disposed inside the wearable module 1 and carried by the wearable module 1, and the imaging auxiliary module 4 can be configured to be used in a floating projection system. In addition, the imaging auxiliary module 4 may include a first optical structure layer 41 disposed between the image display module 2 and the optical imaging module 3 and a second optical structure layer 42 disposed between the optical imaging module 3 and the wearable module 1 (or the light-transmitting panel 112). Furthermore, the first optical structure layer 41 may be configured as one or a combination of a first light diffusion film, a first anti-reflection film, a first filter film, a first polarizing film, and a first brightness enhancement film, and the second optical structure layer 42 may be configured as one or a combination of a second light diffusion film, a second anti-reflection film, a second filter film, a second polarizing film, and a second brightness enhancement film. Therefore, the first image beams L1 generated by the image display module 2 may be transmitted to the optical imaging module 3 through the first optical structure layer 41, and the second image beams L2 converted by the optical imaging module 3 may be transmitted to an upper area (i.e., a virtual plane) located above the wearable module 1 through the second optical structure layer 42.

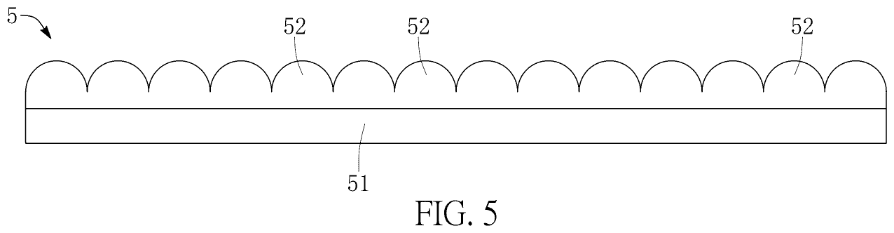

For example, as shown in FIG. 1, FIG. 3 and FIG. 5, the wearable device W may further include a stereoscopic imaging module 5 disposed inside the wearable module 1 and carried by the wearable module 1, and the stereoscopic imaging module 5 may be configured to be applied in a floating projection system. In addition, the stereoscopic imaging module 5 may include a light-transmitting carrier substrate 51 and a plurality of stereoscopic grating structures 52 disposed on the light-transmitting carrier substrate 51. It is worth noting that the light-transmitting carrier substrate 51 and the stereoscopic grating structures 52 may be optical components different from each other, or the light-transmitting carrier substrate 51 and the stereoscopic grating structures 52 may also be integrated into a single optical component. Therefore, when the stereoscopic imaging module 5 is disposed above the image display module 2, the stereoscopic grating structures 52 may be configured to convert the first image beams L1 generated by the image display module 2 into a plurality of stereoscopic image beams, so that the floating image M (or a planar floating image) formed by the cooperation of the second image beams L2 may be converted into a stereoscopic floating image.

For example, as shown in FIG. 1, FIG. 2 and FIG. 3, the wearable device W may further include a gesture sensing module 6 disposed inside the wearable module 1 and carried by the wearable module 1, and the gesture sensing module 6 can be electrically connected to the signal control module S. In addition, the gesture sensing module 6 may include a plurality of gesture sensors 60, and each gesture sensor 60 may be configured as one or a combination of an infrared sensor, a photoelectric sensor (such as a camera module using a photoelectric sensor such as CMOS, CCD, or a device using a laser or photo sensor using photoelectric signal conversion) and an ultrasonic sensor. Therefore, when the gesture sensors 60 are disposed on the inner side of the light-transmitting panel 112, the gesture sensors 60 may be configured to sense the position and movement of the user's finger F relative to the floating image M, so that the user can input at least one operation instruction (or manual operation instruction) to the wearable device W for controlling the floating image M.

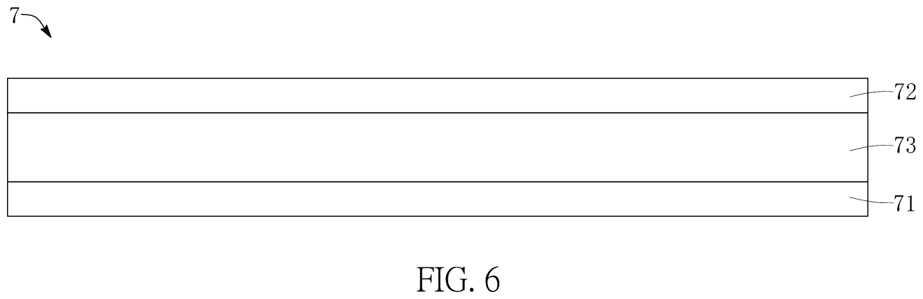

For example, referring to FIG. 1, FIG. 2, FIG. 3 and FIG. 6, the wearable device W may further include an electrochromic module 7 disposed outside the wearable module 1 and carried by the wearable module 1. The electrochromic module 7 may be disposed on the outer surface of the light-transmitting panel 112 of the wearable module 1, and the electrochromic module 7 can be electrically connected to the signal control module S. In addition, the electrochromic module 7 may include a first light-transmitting carrier substrate 71 (such as a transparent glass or plastic substrate), a second light-transmitting carrier substrate 72 (such as a transparent glass or plastic substrate), and an electrochromic unit 73 disposed between the first light-transmitting carrier substrate 71 and the second light-transmitting carrier substrate 72 (such as including a first transparent conductive layer, an electrochromic layer, an electrolyte layer, an ion storage layer, and a second transparent conductive layer). Therefore, when a predetermined voltage is applied to the first transparent conductive layer and the second transparent conductive layer, a certain electric field will be generated between the first transparent conductive layer and the second transparent conductive layer, and an oxidation-reduction reaction will occur under the action of the electric field, thereby causing the electrochromic layer to change color.

For example, referring to FIG. 1, FIG. 2 and FIG. 3, the wearable device W may further include a tactile feedback module 8 disposed inside the wearable module 1 and carried by the wearable module 1, and the tactile feedback module 8 can be electrically connected to the signal control module S. In addition, the tactile feedback module 8 may include a plurality of tactile feedback units 80, and each tactile feedback unit 80 may be configured as a gas jet feedback unit or an ultrasonic vibration feedback unit, thereby providing a tactile feedback feeling of touching the floating image M to the user's finger F (that is to say, the user's finger F can get the feeling of being touched or pushed by an external force). In one of the feasible embodiments, when the user's finger F touches a command area (such as a floating button area) of the floating image M, at least one of the gesture sensors 60 will detect the position and movement of the user's finger F, and at least one of the tactile feedback units 80 will provide a tactile feedback feeling to the user's finger F, whereby the signal control module S electrically connected to the gesture sensors 60 will input an operation instruction to the wearable device W for controlling the floating image M. In one of the feasible embodiments, when the user's finger F performs an image sliding action (or a finger sliding action) on the floating image M, at least one of the gesture sensors 60 will detect the position and movement of the user's finger F, and at least one of the tactile feedback units 80 will provide a tactile feedback feeling to the user's finger F, whereby the signal control module S electrically connected to the gesture sensors 60 will perform an operation instruction of sliding or switching image screen on the floating image M of the wearable device W.

For example, as shown in FIG. 1, FIG. 2 and FIG. 3, the wearable device W may further include a movable carrier module 9 (or an orientation adjustment module) disposed inside the wearable module 1 and carried by the wearable module 1, and the movable carrier module 9 can be electrically connected to the signal control module S. In addition, the movable carrier module 9 may be configured to carry the image display module 2, and the movable carrier module 9 (such as an XYZR four-axis mobile platform) may include a horizontal position moving unit (such as an X-axis table and a Y-axis table that can move in the horizontal direction), a vertical position moving unit (a Z-axis table that can move in the vertical direction) and a tilt angle moving unit (an R-axis table that can rotate 360 degrees or tilt at a specific angle). In one of the feasible embodiments, the movable carrier module 9 can be configured to drive the image display module 2 to move in an inclined manner relative to the optical imaging module 3, thereby adjusting the inclination angle (or the tilt angle) of the floating image M relative to the optical imaging module 3 (that is to say, the movable carrier module 9 can be configured to adjust the inclination angle of the floating image M relative to the optical imaging module 3 by driving the image display module 2 to move in an inclined manner). In one of the feasible embodiments, the movable carrier module 9 can be configured to drive the image display module 2 to move vertically relative to the optical imaging module 3, thereby adjusting the image area of the floating image M (that is to say, the movable carrier module 9 can be configured to adjust the screen size of the floating image M by driving the image display module 2 to move in a vertical manner).

Therefore, referring to FIG. 3 and FIG. 4, when the second image light beams L2 generated by the optical conversion of the optical imaging module 3 pass through the light-transmitting panel 112 to leave the wearable module 1, the second image light beams L2 can cooperate with each other to form a floating image M on a virtual plane above the wearable module 1, thereby allowing the wearable device W to be configured to provide the floating image M for the user to watch.

### Second Embodiment

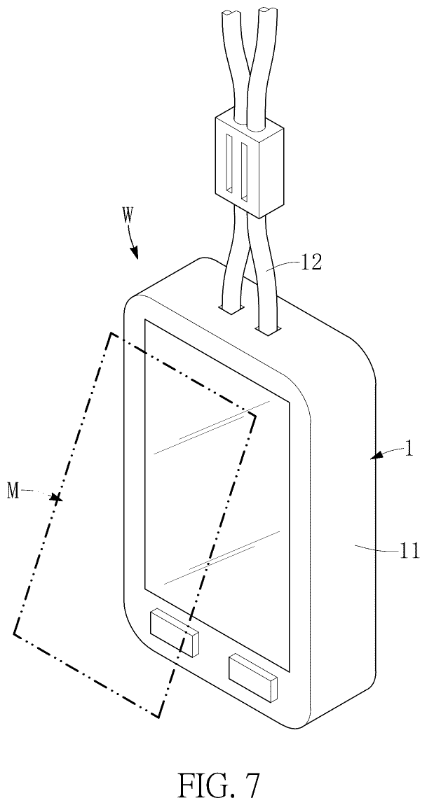

Referring to FIG. 7, a second embodiment of the present disclosure provides a wearable device W for providing a floating image M. Comparing FIG. 7 with FIG. 1, the main difference between the second embodiment and the first embodiment is as follows: in the second embodiment, the device casing structure 11 of the wearable module 1 can be configured as a pendant shell (or a mobile phone shell, or any portable device shell that the user can hold and watch), and the wearable structure 12 of the wearable module 1 can be configured as a neck hanging rope (or a neck hanging necklace).

### Third Embodiment

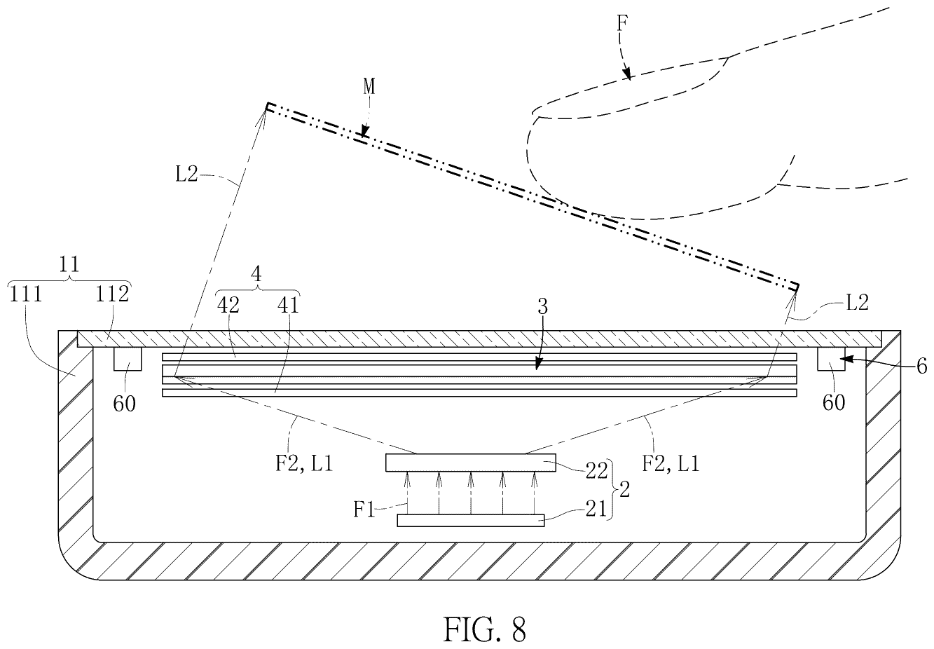

Referring to FIG. 8, a third embodiment of the present disclosure provides a wearable device W for providing a floating image M, which may at least include a wearable module 1, an image display module 2 and an optical imaging module 3. Comparing FIG. 8 with FIG. 3, the main difference between the third embodiment and the first embodiment is as follows: in the third embodiment, when the image display module 2 can be configured as a focusing image display module, the image display module 2 may include an image display 21 and an optical lens group 22 (or an optical focusing lens group) corresponding to the image display 21. Furthermore, the image display 21 of the image display module 2 can be configured to generate a plurality of initial image beams F1 (or a plurality of unfocused image beams), and the optical lens group 22 of the image display module 2 can be configured to convert the initial image beams F1 into a plurality of focused image beams F2. For example, the image display 21 can be configured as a liquid crystal display (such as a TFT display) or a light-emitting diode display (such as a micro OLED display, a micro LED display, or a mini LED display).

Therefore, as shown in FIG. 8, when the image display module 2 can be configured as a focusing image display module, the optical imaging module 3 can be configured to convert the focusing image beams F2 (i.e., the first image beams L1) provided by the image display module 2 into the second image beams L2 that are projected toward a second predetermined direction to leave the wearable module 1.

### Fourth Embodiment

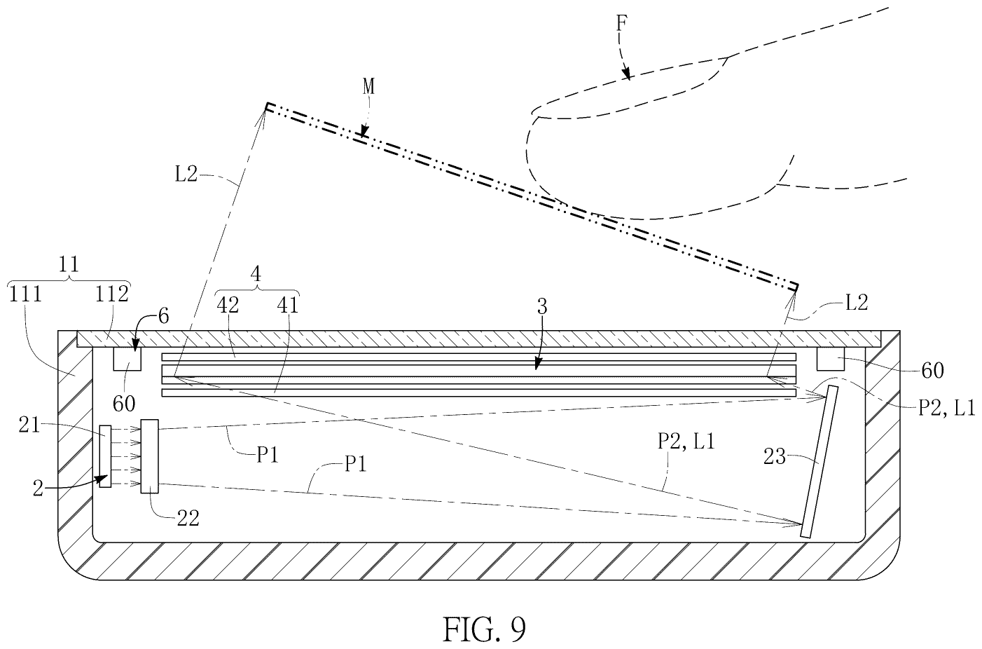

Referring to FIG. 9, a fourth embodiment of the present disclosure provides a wearable device W for providing a floating image M, which may at least include a wearable module 1, an image display module 2 and an optical imaging module 3. Comparing FIG. 9 with FIG. 3, the main difference between the fourth embodiment and the first embodiment is as follows: in the fourth embodiment, when the image display module 2 can be configured as a reflective image display module, the image display module 2 may include an image display 21, an optical lens group 22 (or an optical focusing lens group) corresponding to the image display 21, and a light reflecting element 23 corresponding to the image display 21 (or corresponding to the optical lens group 22). Furthermore, the image display 21 (or the optical lens group 22) of the image display module 2 can be configured to generate a plurality of projected image beams P1, and the light reflecting element 23 of the image display module 2 can be configured to convert the projected image beams P1 into a plurality of reflected image beams P2. For example, the image display 21 can be configured as a micro liquid crystal display (such as a TFT display) or a micro light-emitting diode display (such as a micro OLED display, a micro LED display or a mini LED display).

Therefore, as shown in FIG. 9, when the image display module 2 can be configured as a reflective image display module, the optical imaging module 3 can be configured to convert the reflected image beams P2 (i.e., the first image beams L1) provided by the image display module 2 into a plurality of second image beams L2 that are projected toward a second predetermined direction to leave the wearable module 1.

### Fifth Embodiment

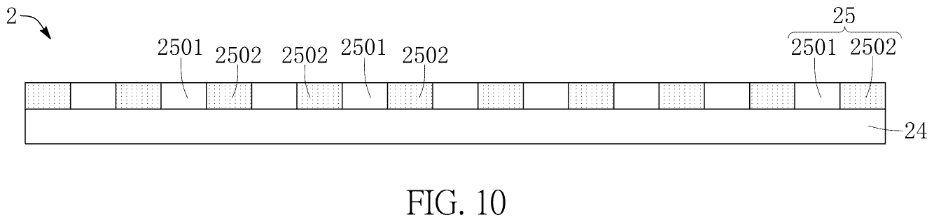

Referring to FIG. 10, the fifth embodiment of the present disclosure provides an image display module 2 for a wearable device. When the image display module 2 can be configured as a patterned image display module, the image display module 2 may include a light source generator 24 and a patterned structure layer 25 disposed on the light source generator 24. Furthermore, the patterned structure layer 25 may include a patterned light-transmitting area 2501 configured to allow a plurality of first predetermined light beams (i.e., a portion of the predetermined light beams) provided by the light source generator 24 to pass through, and a patterned opaque area 2502 for shielding a plurality of second predetermined light beams (i.e., another portion of the predetermined light beams) provided by the light source generator 24. Therefore, the wearable device using the image display module 2 provided by the fifth embodiment can be configured to provide a floating image (i.e., a fixed patterned floating image) corresponding to the patterned light-transmitting area 2501 for the user to watch.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

What is claimed is:

1. A wearable device for providing floating images, comprising:
a wearable module configured to be wearably disposed on a user;
an image display module configured to be disposed inside the wearable module and carried by the wearable module; and
an optical imaging module configured to be disposed inside the wearable module and carried by the wearable module;
wherein the image display module is configured to provide a plurality of first image beams projected toward a first predetermined direction onto the optical imaging module inside the wearable module;
wherein the optical imaging module is configured to respectively convert the first image beams provided by the image display module into a plurality of second image beams that are projected toward a second predetermined direction to leave the wearable module, thereby enabling the wearable device to be configured to provide a floating image composed of the second image beams;
wherein the first predetermined direction and the second predetermined direction are different or the same; and
wherein the second image beams cooperate with each other to form the floating image on a virtual plane above the wearable module, thereby enabling the wearable device to be configured to provide the floating image for the user to watch.

2. The wearable device for providing floating images according to claim 1,
wherein the wearable device further includes an imaging auxiliary module disposed inside the wearable module and carried by the wearable module, and the imaging auxiliary module includes a first optical structure layer disposed between the image display module and the optical imaging module, and a second optical structure layer disposed between the optical imaging module and the wearable module;
wherein the wearable device further includes a stereoscopic imaging module disposed inside the wearable module and carried by the wearable module, and the stereoscopic imaging module includes a light-transmitting carrier substrate and a plurality of stereoscopic grating structures disposed on the light-transmitting carrier substrate;
wherein the wearable device further includes a gesture sensing module disposed inside the wearable module and carried by the wearable module;
wherein the wearable device further includes an electrochromic module disposed outside the wearable module and carried by the wearable module;
wherein the wearable device further includes a tactile feedback module disposed inside the wearable module and carried by the wearable module;
wherein the wearable device further includes a movable carrier module disposed inside the wearable module and carried by the wearable module, and the movable carrier module is configured to carry the image display module;
wherein the movable carrier module is configured to drive the image display module to move tiltedly relative to the optical imaging module, thereby adjusting a tilt angle of the floating image relative to the optical imaging module; and
wherein the movable carrier module is configured to drive the image display module to move vertically relative to the optical imaging module, thereby adjusting an image area of the floating image.

3. The wearable device for providing floating images according to claim 1,
wherein the wearable module includes a device casing structure and a wearable structure connected to the device casing structure;
wherein the device casing structure of the wearable module includes an opaque casing and a light-transmitting panel disposed on the opaque casing, and the second image light beams pass through the light-transmitting panel to leave the wearable module;
wherein the optical imaging module is configured as a dihedral corner reflector array element;
wherein the optical imaging module includes a light-transmitting carrier substrate and an optical imaging assembly disposed on the light-transmitting carrier substrate, and the optical imaging assembly includes a plurality of micro-prism arrays or a plurality of micro-reflector arrays that cooperate with each other; and
wherein the optical imaging assembly is configured to provide a plurality of first reflection surfaces arranged in parallel to each other and a plurality of second reflection surfaces arranged in parallel to each other, and each of the first image light beams generated by the image display module is sequentially reflected by two adjacent ones of the first reflection surfaces and a corresponding one of the second reflection surfaces so as to leave the optical imaging assembly.

4. The wearable device for providing floating images according to claim 1, wherein the image display module is configured as a direct projection image display module.

5. The wearable device for providing floating images according to claim 1, wherein the image display module is configured as a focusing image display module.

6. The wearable device for providing floating images according to claim 1, wherein the image display module is configured as a reflective image display module.

7. The wearable device for providing floating images according to claim 1, wherein the image display module is configured as a patterned image display module.

8. The wearable device for providing floating images according to claim 1, wherein the wearable device further includes a movable carrier module disposed inside the wearable module and carried by the wearable module, and the movable carrier module is configured to carry the image display module.

9. The wearable device for providing floating images according to claim 8, wherein the movable carrier module is configured to drive the image display module to move tiltedly relative to the optical imaging module, thereby adjusting a tilt angle of the floating image relative to the optical imaging module.

10. The wearable device for providing floating images according to claim 8, wherein the movable carrier module is configured to drive the image display module to move vertically relative to the optical imaging module, thereby adjusting an image area of the floating image.
